(19) United States
(12) Patent Application Publication
(10) Pub. No.: US 2005/0238926 A1
(43) Pub. Date: Oct. 27, 2005

(54) Substrate for a perpendicular magnetic recording medium and a perpendicular magnetic recording medium using the substrate

(75) Inventors: Hiroyuki Uwazumi, Minami-Alps-City (JP); Norihiko Nakajima, Matsumoto-City (JP); Tatsumi Kawata, Matsumoto-City (JP); Kazuhito Higuchi, Minami-Alps-City (JP)

Correspondence Address: ROSSI, KIMMS & McDOWELL LLP., P.O. BOX 826, ASHBURN, VA, 20146-0826, US

(73) Assignee: Fuji Electric Device Technology Co., Ltd, Shinagawa-ku (JP)

(21) Appl. No.: 11/078,199

(22) Filed: Mar. 11, 2005

(30) Foreign Application Priority Data
Apr. 1, 2004 (JP) PA 2004 - 108972

(51) Int. Cl. G11B 5/64

(52) U.S. Cl. 428/846.2; 428/846.6; 428/832

(57) ABSTRACT

A substrate for a perpendicular magnetic recording medium and a perpendicular magnetic recording medium using such a substrate are disclosed. The substrate exhibits sufficient productivity and functions as a soft magnetic backing layer of a perpendicular magnetic recording medium based on the substrate, ensuring surface hardness. The substrate comprises a nonmagnetic base plate composed of an aluminum alloy, an adhesion layer formed on the nonmagnetic base plate and composed of a material containing at least nickel, and a soft magnetic underlayer formed on the adhesion layer by means of an electroless plating method. The soft magnetic underlayer contains phosphorus in a range of 3 at % to 20 at %, and at least 25 at % of cobalt in proportion to the number of atoms of cobalt and nickel excluding the phosphorus (Co/(Co+Ni)). Thickness of the adhesion layer is at least 0.1 μm. Thickness of the soft magnetic underlayer is at least 0.2 μm, and a sum of the thickness of the adhesion layer and the thickness of the soft magnetic underlayer is at least 3 μm.

### CROSS REFERENCE TO RELATED APPLICATIONS

This application claims priority from application Serial No. 2004-108972, filed on Apr. 1, 2004, the contents of which are incorporated herein by reference.

### BACKGROUND OF THE INVENTION

A. Field of the Invention

The present invention relates to a substrate for a perpendicular magnetic recording medium and a perpendicular magnetic recording medium mounted on an external storage device of a computer and other magnetic recording devices, in particular to a perpendicular magnetic recording medium suited for mounting on a hard disk drive (HDD), and a substrate for such a perpendicular magnetic recording medium.

B. Description of the Related Art

A perpendicular magnetic recording system is receiving attention as a technique for achieving high density magnetic recording in place of a conventional longitudinal magnetic recording system.

In particular, a double layer perpendicular magnetic recording medium is known to be suited for a perpendicular magnetic recording medium for achieving high density recording, as disclosed in Japanese Patent Publication No. S58-91. A double layer perpendicular magnetic recording medium is provided with a soft magnetic film called a soft magnetic backing layer under a magnetic recording layer that stores information. The soft magnetic backing layer, exhibiting high saturation magnetic flux density, facilitates passage of the magnetic flux generated by a magnetic head. The double layer perpendicular magnetic recording medium increases intensity and gradient of the magnetic field generated by the magnetic head to improve recording resolution, and also increases the leakage flux from the medium.

The soft magnetic backing layer generally uses a Ni—Fe alloy film, an Fe—Si—Al alloy film, or an amorphous alloy film of mainly cobalt having a thickness in a range of about 200 nm to 500 nm formed by a sputtering method. To form such a relatively thick film by a sputtering method is not appropriate from the viewpoint of production costs and mass productivity.

To solve the problem, the use of a soft magnetic film formed by an electroless plating method has been proposed for the soft magnetic backing layer. Japanese Unexamined Patent Application Publication No. H7-66034, for example, proposes a soft magnetic backing layer using a NiFeP film produced by a plating method. A CoNiFeP plating film is proposed in Digest of 9th Joint MMM/Intermag Conference, EP-12, p. 259 (2004), and a ferromagnetic NiP plating film is proposed in Digest of 9th Joint MMM/Intermag Conference, GD-13, p. 368 (2004).

It is known that if the soft magnetic backing layer forms a magnetic domain structure and generates a magnetization transition region called a magnetic domain wall, the noise called spike noise that is generated from the magnetic domain wall degrades performance of the perpendicular magnetic recording medium. Therefore, a soft magnetic backing layer needs to suppress formation of the magnetic domain wall.

Since the NiFeP plating film is apt to form a magnetic domain wall, J. of The Magnetics Society of Japan, vol. 28, No. 3, p. 289 (2004) discloses that the magnetic domain wall formation should be suppressed by forming a MnIr alloy thin film on the plating film by a sputtering method. The suppression of the magnetic domain wall formation in the above-mentioned CoNiFeP plating film is said to be possible by plating in a magnetic field. The ferromagnetic NiP plating film is deemed not to generate spike noise.

Japanese Unexamined Patent Application Publication No. H2-18710 also proposes that the generation of spike noise can be suppressed by forming a backing layer composed of cobalt or a CoNi alloy having coercivity Hc in a range of 30 to 300 Oe in such a way as to exhibit magnetic anisotropy in the circumferential direction of the disk substrate. While the backing layer in this example is formed by a dry deposition process, such as a sputtering method or an evaporation method, Japanese Unexamined Patent Application Publication No. H5-1384 proposes a method to form a Co—B film having Hc of at least 30 Oe and suppressing spike noise by a plating method, and suggests applicability to a soft magnetic backing layer.

A magnetic recording medium (hard disk) of a hard disk drive practically used at present that employs a longitudinal magnetic recording system uses a nonmagnetic substrate comprising a nonmagnetic Ni—P plating film containing phosphorus in a concentration of about 20 atomic percent (at %) with a thickness in a range of about 8 μm to 15 μm formed on an aluminum alloy base plate by an electroless plating method.

This nonmagnetic Ni—P plating film principally works to fill in defects such as dents on the base plate of aluminum alloy and to attain a smooth surface by polishing the surface of the plating film. The plating film is also used for ensuring the surface hardness required by a substrate for a hard disk. A substrate for a hard disk is considered necessary to secure a certain degree of surface hardness to avoid damage on collision of the magnetic head with the magnetic recording medium during operation of the hard disk drive.

To suppress spike noise in the NiFeP plating film described previously, the magnetic domain wall formation needs to be suppressed by forming a MnIr alloy thin film on the plating film by a sputtering method. The requirement for provision of an additional film by a sputtering method to suppress the magnetic domain wall formation detracts from the merit of the plating method in production costs and mass productivity, and thus is undesirable. The CoNiFeP plating film described above also finds difficulty in applying a homogeneous magnetic field to the substrate in the plating bath in an actual manufacturing process, and so very likely impairs the mass productivity.

Although an iron-containing plating film that exhibits high saturation magnetic flux density Bs is suitable for a soft magnetic backing layer, ensuring the stability of a plating bath is known to be generally difficult because iron ions take stable forms as both divalent and trivalent ions. So the iron-containing plating film is also defective in mass productivity.

Regarding the ferromagnetic NiP plating film described above, nickel exhibits Bs of a low value of 0.65 T, and phosphorus that is added to carry out the electroless plating with high productivity further lowers the Bs. So a prediction can be made that the ferromagnetic NiP plating layer has a relatively poor effect with regard to improving recording and reproduction performance of a perpendicular magnetic recording medium.

The inventors have studied the correlation between coercivity and magnetic domain wall formation of the soft magnetic underlayer formed by a plating method, and found that a coercivity value of the plating film of not smaller than 30 Oe cannot completely prevent the magnetic domain wall formation, although some tendency of suppression was observed. It has been further clarified that the increase of the coercivity deteriorates recording and reproduction performance.

As described above, the conventional technology fails to achieve a backing layer of a perpendicular magnetic recording medium that allows high density recording and suppresses spike noise, and is still accompanied by low production costs and satisfactory mass productivity. In addition, a soft magnetic plating film for use in a substrate for a hard disk must be produced so that the surface roughness and the surface hardness endure operations as a substrate for a hard disk.

The present invention is directed to overcoming or at least reducing the effects of one or more of the problems set forth above.

### SUMMARY OF THE INVENTION

In view of the above, an object of the present invention is to provide a substrate for a perpendicular magnetic recording medium, the substrate allowing mass production, serving a function as a soft magnetic backing layer of a perpendicular magnetic recording medium, and ensuring surface hardness. Another object of the invention is to provide a perpendicular magnetic recording medium using such a substrate.

The inventors have made extensive studies to solve the above problems and found that a substrate for a perpendicular magnetic recording medium allowing mass production, serving a function as a soft magnetic backing layer of a perpendicular magnetic recording medium, and ensuring surface hardness can be achieved by forming an adhesion layer composed of a material containing at least nickel on a nonmagnetic base plate composed of an aluminum alloy, and forming a soft magnetic underlayer composed of a Co—Ni—P alloy at least containing phosphorus in a range of 3 at % to 20 at % and cobalt at least 25 at % in a proportion of number of atoms of cobalt and nickel excluding the phosphorus (Co/(Co+Ni)), and making the thickness of the adhesion layer at least 0.1 μm, the thickness of the soft magnetic underlayer at least 0.2 μm, and the sum of the thicknesses of the adhesion layer and the soft magnetic underlayer at least 3 μm.

Interposing the adhesion layer of a nickel alloy between the nonmagnetic base plate of an aluminum alloy and the soft magnetic underlayer, adhesion between the nonmagnetic base plate of an aluminum alloy and a soft magnetic underlayer of a Co—Ni—P alloy can be enhanced. A thickness of the adhesion layer for the purpose is preferably at least 0.1 μm.

A thickness of the soft magnetic underlayer needs to be at least 0.2 μm to serve a function as a soft magnetic backing layer for a perpendicular magnetic recording medium capable of high density recording.

An upper limit of the thicknesses of the soft magnetic underlayer and the adhesion layer, though not strictly confined in a special range is preferably at most 15 μm, and more preferably at most 7 μm, from the viewpoint of manufacturing costs. The sum of the thicknesses of the soft magnetic underlayer and the adhesion layer must be at least 3 μm to ensure hardness of the substrate surface.

A material of the adhesion layer is necessarily a material containing at least nickel to improve adhesion between the nonmagnetic base plate and the soft magnetic underlayer. Materials suited for the adhesion layer include, for example, pure nickel, a Ni—Co alloy, and a Ni—P alloy formed by a sputtering method, and a Ni—P alloy and a Ni—B alloy formed by an electroless plating method. More favorable materials among them are nonmagnetic NiP alloys including a nonmagnetic NiP alloy with a phosphorus concentration of about 20 at % formed by an electroless plating method and a NiMoP alloy with an addition of molybdenum for enhancing heat-resistance stability. Use of these materials for the adhesion layer maintain high productivity and never affect recording and reproduction performance because they are nonmagnetic substances.

Concerning composition of the soft magnetic underlayer, a phosphorus concentration below 3 at % hardly allows for a stable electroless plating layer to be formed, while a phosphorus concentration over 20 at % results in a Bs value that is too low, and the result cannot perform its function as a soft magnetic backing layer. A cobalt concentration lower than 25 at % in a proportion of number of atoms of cobalt and nickel excluding phosphorus is not appropriate since the Bs value cannot be maintained sufficiently high. Although an upper limit of the cobalt concentration is not strictly limited to a special value, a cobalt concentration over 90 at % in a proportion of number of atoms of cobalt and nickel excluding phosphorus tends to make the CoNi alloy take on an hcp structure having a large crystalline magnetic anisotropy constant and to increase coercivity, and is thus unfavorable. The composition preferably contains at least 10 % of nickel in a proportion of number of atoms of cobalt and nickel excluding phosphorus to stably form an fcc structure.

A cobalt concentration of at least 50 at % and less than 90 % in a proportion of number of atoms of cobalt and nickel excluding phosphorus is more preferable because a high Bs value and excellent soft magnetic property are attained, and the function as a soft magnetic backing layer can be performed most effectively.

The inclusion of germanium or lead of at most several at % in the soft magnetic underlayer for the purpose of improvement of corrosion resistance and stabilization of the plating bath does not detract from advantages of the present invention.

To use a substrate with such a structure for a disk substrate of a hard disk, a soft magnetic underlayer necessarily has a surface roughness Ra of at most 0.5 nm and a micro surface waviness Wa of at most 0.5 nm to attain a flight height of about 10 nm or smaller of a magnetic head for recording and reproduction of information. Such a smooth surface is effectively obtained by polishing the surface of the soft magnetic underlayer using a suspended abrasive such as aluminum oxide or colloidal silica.

A heating process may be carried out after formation of the soft magnetic underlayer or after the smoothing process described above, although the desired performance can be obtained without the heating process in the plating film of the invention.

The inventors of the present invention have made extensive studies on the suppression of the magnetic domain wall formation in the soft magnetic underlayer of the CoNiP plating and found that a ratio Mrrδ/Mrcδ needs to be controlled in a range of 0.33 to 3.00, where Mrcδ is a product of thickness and residual magnetization obtained from a magnetization curve measured by applying a magnetic field along a circumferential direction of the disk substrate, and Mrrδ is a product of thickness and residual magnetization obtained from a magnetization curve measured by applying a magnetic field along a radial direction of the disk substrate.

The magnetization tends to align along the circumferential direction of the disk substrate if Mrrδ/Mrcδ is smaller than 0.33, and tends to align along the radial direction of the disk if Mrrδ/Mrcδ is larger than 3.00. As a result, the magnetic domain walls are liable to be formed along the respective directions, generating undesirable spike noise.

The inventors have also found that the Hc value does not strongly correlate to the magnetic domain wall formation, and the recording and reproduction performance improves with the Hc value of not larger than about 20 Oe rather than with the Hc value of at least 30 Oe, which is taught by Japanese Unexamined Patent Application Publication No. H2-18710 and Japanese Unexamined Patent Application Publication No. H5-1384.

A perpendicular magnetic recording medium of the invention uses the above-described substrate for a perpendicular magnetic recording medium according to the invention and comprises at least a nonmagnetic seed layer, a magnetic recording layer, and a protective layer sequentially formed on the substrate. According to the study by the inventors, such a perpendicular magnetic recording medium has favorable recording and reproduction performances as a double layer perpendicular magnetic recording medium since the soft magnetic underlayer on the uppermost surface of the disk substrate functions as a soft magnetic backing layer. In addition, the soft magnetic backing layer is formed by means of an electroless plating method that is conducted with high mass productivity. Therefore, the medium is manufactured very inexpensively because the backing layer need not be formed by a sputtering method, for example.

Advantageously, a soft magnetic auxiliary layer that exhibits a product of thickness and saturation magnetic flux density of at least 150 G μm and the thickness of at most 50 nm is provided between the soft magnetic underlayer on the uppermost surface of the substrate and the nonmagnetic seed layer. Because both this soft magnetic auxiliary layer and the soft magnetic underlayer work as a soft magnetic backing layer, the function for a double layer perpendicular medium improves and the auxiliary layer exhibits the effect to suppress random noises generated in the soft magnetic underlayer.

The soft magnetic auxiliary layer preferably has a product of thickness and saturation magnetic flux density of at least 150 G μm to improve the function as a soft magnetic backing layer. The thickness is preferably at most 50 nm. A thickness larger than 50 nm is liable to form magnetic domain walls in the soft magnetic auxiliary layer and generates spike noises, and further, deteriorates productivity.

The present invention provides such a substrate for a perpendicular magnetic recording layer that allows mass production, supplies the function as a soft magnetic backing layer of a perpendicular magnetic recording medium, ensures surface roughness, and generates little spike noise.

A perpendicular magnetic recording medium of the invention, using a substrate for a perpendicular magnetic recording medium of the invention, achieves favorable recording and reproduction performance. Because the soft magnetic backing layer in the medium of the invention is formed by an electroless plating method that allows mass production, a relatively thick film required for a soft magnetic backing layer need not be formed by, for example, a sputtering method, permitting very inexpensive production.

### BRIEF DESCRIPTION OF THE DRAWINGS

The foregoing advantages and features of the invention will become apparent upon reference to the following detailed description and the accompanying drawings, of which:

FIG. 1 is a schematic sectional view of a structure of a substrate for a perpendicular magnetic recording medium of an embodiment according to the invention;

FIG. 2 is a schematic sectional view showing a structure of a perpendicular magnetic recording medium of an embodiment according to the invention;

FIG. 3 is a schematic sectional view showing a structure of a perpendicular magnetic recording medium comprising a soft magnetic auxiliary layer of an embodiment according to the invention;

FIG. 4 shows the reproduced output signal at a recording density of 300 kFCl of perpendicular magnetic recording media with various film thicknesses of the soft magnetic underlayer in the dependence on the write current in the magnetic head;

FIG. 5 shows the reproduced output signal at a recording density of 300 kFCl of perpendicular magnetic recording media with various mean phosphorus concentration in the soft magnetic underlayer in the dependence on the write current in the magnetic head;

FIG. 6 shows the reproduced output signal at a recording density of 300 kFCl of perpendicular magnetic recording media with various mean cobalt concentration in the soft magnetic underlayer in a proportion of number of atoms of cobalt and nickel excluding the phosphorus (Co/(Co+Ni)) in the dependence on the write current in the magnetic head;

FIG. 7 shows typical magnetization curves and the definitions of the residual magnetization and the coercivity of a soft magnetic underlayer, in which (a) shows the ones along the radial direction of the disk, and (b) shows the ones along the circumferential direction of the disk; and

FIG. 8 shows the signal-to-noise ratio (SNR) at a recording density of 370 kFCl in the dependence on the thickness of the soft magnetic auxiliary layer.

### DETAILED DESCRIPTION OF SPECIFIC EMBODIMENTS

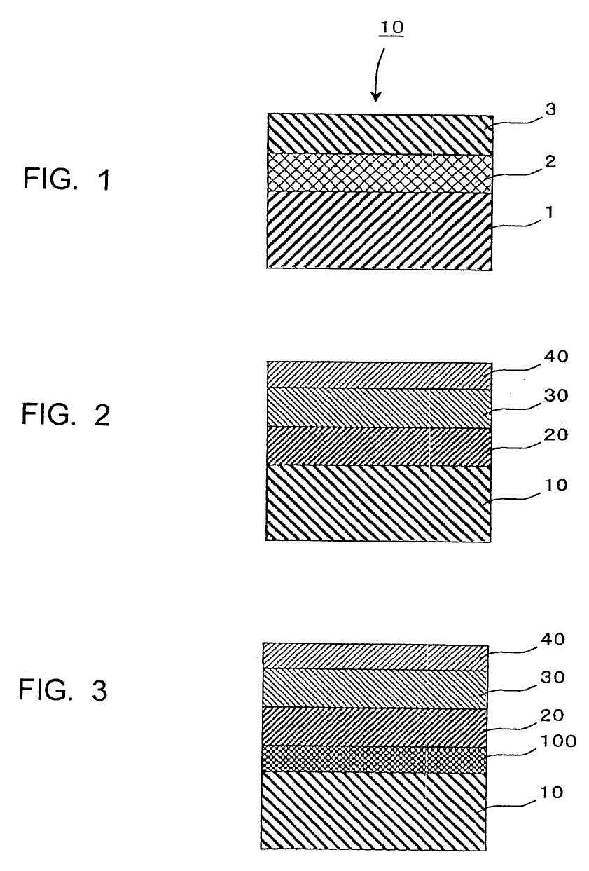

FIG. 1 shows a structure of a substrate for a perpendicular magnetic recording medium of an embodiment of the invention. Substrate 10 for a perpendicular magnetic recording medium of the embodiment shown in FIG. 1 comprises nonmagnetic base plate 1, adhesion layer 2 on the base plate, and soft magnetic underlayer 3 on the adhesion layer. Adhesion layer 2 and soft magnetic underlayer 3 may be formed on the other side of nonmagnetic base plate 1, but are not shown in FIG. 1.

Nonmagnetic base plate 1 can be composed of a disk-shaped Al—Mg alloy plate used in a substrate for a conventional hard disk or the like material. In the case of substrates with a shape other than a disk (for example, a drum), a disk circumferential direction in the following description should be replaced by a head running direction and a disk radial direction by a direction in the medium surface perpendicular to the head running direction, and the effects of the invention are conserved.

The material of adhesion layer 2 must contain at least nickel so as to enhance the adhesion between nonmagnetic base plate 1 and soft magnetic underlayer 3. Materials that are favorably used for the adhesion layer include pure nickel, a Ni—Co alloy, and a Ni—P alloy that are formed by a sputtering method, and a Ni—P alloy and a Ni—B alloy that are formed by an electroless plating method.

Among the above-mentioned materials, a nonmagnetic NiP alloy with a phosphorus concentration of about 20 at % formed by an electroless plating method and a NiMoP alloy containing molybdenum added for enhancing the stability of heat resistance are more favorable for a material of the adhesion layer. These materials preserve high productivity and do not relate to recording and reproduction property because the materials are nonmagnetic. The thickness of adhesion layer 2 needs to be at least 0.1 μm to secure the adhesion between nonmagnetic base plate 1 and soft magnetic underlayer 3.

Soft magnetic underlayer 3 formed on adhesion layer 2 is composed of a CoNiP alloy formed by an electroless plating method. Soft magnetic underlayer 3 is necessarily a CoNiP alloy that contains phosphorus in a range of 3 at % to 20 at % and cobalt at least_{—}25 at % in proportion to the number of atoms of cobalt and nickel excluding the phosphorus. If the phosphorus concentration is less than 3 at %, a stable electroless plating film is hardly formed; if the phosphorus concentration is more than 20 at %, the Bs value becomes too low and the function as a soft magnetic backing layer of a double layer perpendicular magnetic recording medium is not obtained.

The cobalt concentration less than 25 at % in proportion to the number of atoms of cobalt and nickel excluding the phosphorus is not appropriate because a high enough Bs value can not be maintained. Although the maximum value of the cobalt concentration is not limited to a special value, if the cobalt concentration exceeds 90 at % in proportion to the number of atoms of cobalt and nickel excluding the phosphorus, a CoNi alloy generally tends to form an hcp structure that has a large crystalline magnetic anisotropy constant and is apt to increase the coercivity. Accordingly, the cobalt concentration is favorably not larger than 90 at % in proportion to the number of atoms of cobalt and nickel excluding phosphorus. Thus, the composition of the alloy favorably contains at least 10 at % of nickel in proportion to the number of atoms of cobalt and nickel excluding phosphorus to form a stable fcc structure. A cobalt concentration at least 50 at % and less than 90 at % in proportion to the number of atoms of cobalt and nickel excluding phosphorus is more preferable so as to exhibit a high Bs value and a favorable soft magnetic property, and to function most effectively as a soft magnetic backing layer.

The effects of the invention are not obstructed by including germanium or lead of at most several at % in the soft magnetic underlayer for the purpose of improving the corrosion resistance and stabilizing the plating bath.

The thickness of soft magnetic underlayer 3 needs to be at least 0.2 μm for the function as a soft magnetic backing layer for a perpendicular magnetic recording medium. Although the upper limits of thicknesses of soft magnetic underlayer 3 and adhesion layer 2 are not limited to any special values, both thicknesses are favorably not larger than 15 μm, more favorably at most 7 μm, from the viewpoint of manufacturing costs.

The sum of the thicknesses of adhesion layer 2 and soft magnetic underlayer 3 needs to be at least 3 μm to ensure hardness of the substrate surface. Though the upper limit of the sum of the thicknesses is not limited to a special value, the sum is favorably not larger than 15 μm, more favorably at most 7 μm, from the viewpoint of manufacturing costs.

The nonmagnetic NiP alloy composing adhesion layer 2 as described above and the plating film of a CoNiP alloy composing soft magnetic underlayer 3 can be formed by means of a known method of a so-called kanigen plating method using a reducing agent of sodium hypophosphite, and controlling the composition, temperature, and pH of the plaiting bath appropriately.

In application of substrate 10 for a perpendicular magnetic recording medium having the above construction to a disk substrate for a hard disk, soft magnetic underlayer 3 needs to have a surface roughness Ra of not larger than 0.5 nm and a micro surface waviness of not larger than 0.5 nm to hold the flight height of the magnetic head for recording and reproduction of information within about 10 nm. The surface roughness Ra indicates a center line surface roughness of a three dimensional image when a surface geometry is measured in an area of 5 μm square using an atomic force microscope AFM; and the micro surface waviness Wa indicates the waviness that is measured in an area of 1 mm square using an optical surface geometry measuring device made by Zygo Corporation, through a filter of long wavelength of 500 μm and short wavelength of 50 μm.

Such a surface geometry can be effectively attained by polishing and smoothing the surface of soft magnetic underlayer 3 using free abrasive. The polishing can be carried out by a technique similar to a conventional smoothing process of a nonmagnetic Ni—P film. The polishing can be conducted for example, using a double polishing machine with polishing pads of urethane foam and feeding the abrasive of suspended aluminum oxide or colloidal silica.

An embodiment of the invention can be carried out using a substrate for a perpendicular magnetic recording medium commonly used in manufacturing a magnetic recording medium, the substrate comprising an aluminum alloy base plate and a nonmagnetic Ni—P plating layer about 10 μm thick, and having the surface smoothed by polishing. After cleaning the substrate surface, a soft magnetic underlayer composed of a CoNiP alloy according to the invention is formed by an electroless plating method. Such a structure of a substrate is equivalent to substrate 10 for a perpendicular magnetic recording medium according to the invention shown in FIG. 1, and retains the effects of the invention since the nonmagnetic Ni—P plating layer has an effect as adhesion layer 2.

To ensure the surface roughness Ra within 0.5 nm, according to a study of the inventors, the smoothing process as described above is required again after the electroless plating process of soft magnetic underlayer 3 of a CoNiP alloy. From the viewpoint of productivity and costs, the plating process of the soft magnetic underlayer is desirably conducted immediately after plating the nonmagnetic Ni—P layer that is equivalent to adhesion layer 2, omitting the smoothing process.

A heating process may be carried out after formation of the soft magnetic underlayer or after the smoothing process described above, although the desired performance can be obtained without the heating process in the plating film of the invention.

Concerning the suppression of the magnetic domain wall formation in soft magnetic underlayer 3 of the CoNiP plating, a ratio MrrΔ/Mrcδ needs to be controlled in a range of 0.33 to 3.00, where Mrcδ is a product of thickness and residual magnetization obtained from a magnetization curve measured by applying a magnetic field along a circumferential direction of the disk substrate, and Mrrδ is a product of thickness and residual magnetization obtained from a magnetization curve measured by applying a magnetic field along a radial direction of the disk substrate. The magnetization tends to align along the circumferential direction of the disk substrate if Mrrδ/Mrcδ is smaller than 0.33, and tends to align along the radial direction of the disk if Mrrδ/Mrcδ is larger than 3.00. As a result, the magnetic domain walls are liable to be formed along the respective directions, generating undesirable spike noise.

The Hc value does not strongly correlate to the magnetic domain wall formation, and the recording and reproduction performance improves with the Hc value of not larger than about 20 Oe, rather than with the Hc value of not smaller than 30 Oe, which is taught by Japanese Unexamined Patent Application Publication No. H2-18710 and Japanese Unexamined Patent Application Publication No. H5-1384.

The magnitude of the ratio Mrrδ/Mrcδ can be controlled by appropriately adjusting the rotating speed of the nonmagnetic base plate in the plating bath and the composition of the plating bath. The Mrrδ/Mrcδ could also be controlled by applying a magnetic field to the nonmagnetic base plate in the plating bath. The application of a homogeneous magnetic field to the substrate in the plating bath is, however, difficult in a practical production process. Further, the process is very liable to impair the mass productivity.

FIG. 2 shows a structure of a perpendicular magnetic recording medium of an embodiment of the invention. The perpendicular magnetic recording medium of the embodiment shown in FIG. 2 comprises at least nonmagnetic seed layer 20, magnetic recording layer 30, and protective layer 40 sequentially formed on a substrate 10 for a perpendicular magnetic recording medium shown in FIG. 1. Substrate 10 is preferably a disk substrate having a shape of a disk. Though not shown, nonmagnetic seed layer 20, magnetic recording layer 30, and protective layer 40 can also be formed on the other side of substrate 10.

Nonmagnetic seed layer 20 can be composed of a material to control the crystal alignment and the grain size of magnetic recording layer 30 favorably, without any special limitations. When magnetic recording layer 30 is a perpendicular magnetic film composed of a CoCrPt alloy, for example, nonmagnetic seed layer 20 can be composed of a CoCr alloy, titanium or a titanium alloy, or ruthenium or a ruthenium alloy. When magnetic recording layer 30 is a so-called laminated perpendicular magnetization film composed of laminated cobalt alloy layers and platinum or palladium layers, nonmagnetic seed layer 20 can be composed of platinum or palladium. A pre-seed layer or an intermediate layer can be provided on or under nonmagnetic seed layer 20 without obstructing the effects of the invention.

Magnetic recording layer 30 can be composed of any material that allows recording and reproduction in a perpendicular magnetic recording medium. The materials can be selected from the above-mentioned perpendicular magnetization films composed of the CoCrPt alloy, the CoCrPt alloy containing an oxide, or a so-called perpendicular magnetization film comprising layers of a cobalt alloy and platinum or palladium.

Protective layer 40 is a thin film composed mainly of carbon, for example. Protective layer 40 can also be composed of the thin film of mainly carbon and a liquid lubricant layer formed by applying a liquid lubricant such as perfluoropolyether on the thin film.

Nonmagnetic seed layer 20, magnetic recording layer 30, and protective layer 40 can be formed by a thin film formation technique selected from sputtering, CVD, vacuum evaporation, plating, and the like.

A perpendicular magnetic recording medium manufactured as described above has the same favorable recording and reproduction performance as a double layer perpendicular magnetic recording medium since soft magnetic underlayer 3 in substrate 10 (FIG. 1) acts as a soft magnetic backing layer. In addition, the soft magnetic backing layer is formed by an electroless plating method that exhibits high productivity. Therefore, the medium can be manufactured at a very low cost because the backing layer need not be formed by an expensive method of sputtering, for example.

FIG. 3 shows a structure of a perpendicular magnetic recording medium provided with a soft magnetic auxiliary layer of an embodiment of the invention. The perpendicular magnetic recording medium of the embodiment shown in FIG. 3 comprises at least soft magnetic auxiliary layer 100, nonmagnetic seed layer 20, magnetic recording layer 30, and protective layer 40 sequentially formed on substrate 10 for a perpendicular magnetic recording medium shown in FIG. 1.

Substrate 10 is preferably a disk substrate having a shape of a disk. Though not shown, soft magnetic auxiliary layer 100, nonmagnetic seed layer 20, magnetic recording layer 30, and protective layer 40 can also be formed on the other side of substrate 10. Nonmagnetic seed layer 20, magnetic recording layer 30, and protective layer 40 can be composed of materials similar to the materials used in the perpendicular magnetic recording medium shown in FIG. 2.

Soft magnetic auxiliary layer 100 preferably exhibits a product of thickness and saturation magnetic flux density of at least 150 G μm and has a thickness not larger than 50 nm. Examples of the auxiliary layer include a CoZrNb amorphous soft magnetic layer 15 to 50 nm thick having a saturation magnetic flux density of 10,000 G and a FeTaC soft magnetic layer 10 to 50 nm thick having a saturation magnetic flux density of 15,000 G.

When soft magnetic auxiliary layer 100 is provided, both soft magnetic auxiliary layer 100 and the soft magnetic underlayer act as soft magnetic backing layers, improving the performance for a double layer perpendicular medium. In addition, an effect is produced to reduce random noise generated in soft magnetic underlayer 3.

Soft magnetic auxiliary layer 100 preferably exhibits a product of thickness and saturation magnetic flux density of at least 150 G μm for improving the performance as a soft magnetic backing layer. The thickness is preferably not larger than 50 nm. If the thickness is thicker than 50 nm, magnetic domain walls are apt to be formed in soft magnetic auxiliary layer 100 generating spike noise, and also the productivity is deteriorated; thus, such a thickness is unfavorable.

Specific examples of the substrates and the media according to the embodiment of the invention will be described in the following. The examples of substrates are substrate 10 in FIG. 1 that is a disk substrate for a hard disk and comprises adhesion layers 2 and soft magnetic underlayers 3 provided on the front and back surfaces of disk-shaped nonmagnetic base plate 1. The examples of media are hard disks comprising the layers, including magnetic recording layer 30, shown in FIG. 2 and FIG. 3 on both surfaces of substrate 10.

### EXAMPLE 1

A disk-shaped Al—Mg alloy plate having a nominal diameter of 3.5 inches was used for nonmagnetic base plate 1 in FIG. 1. The surface of the base plate is cleaned by alkali washing and acid etching and subjected to zincating (zinc immersion coating) as an initial reaction layer for the electroless Ni—P plating. Then, adhesion layer 2 of a nonmagnetic Ni—P alloy having one of the various thicknesses from zero to 10 μm was formed using a commercially available electroless Ni—P plating liquid for a hard disk substrate (NIMUDEN HDX manufactured by C. Uyemura & Co., Ltd.) in a plating bath controlled in conditions of the nickel concentration at 6.0±0.1 g/liter, pH at 4.5±0.1, and the liquid temperature at 92±1° C. The average phosphorus concentration in the nonmagnetic Ni—P plating film was 20 at %.

Subsequently, soft magnetic underlayer 3 of a CoNiP alloy having one of the various thicknesses from 0.5 to 10 μm was formed using a plating bath (1) shown in Table 1. The substrate was rotated in the plating bath at a rotating speed of 10 rpm. The formed soft magnetic underlayers 3 had an average phosphorus concentration of 15 at % and an average cobalt concentration of 71 at % in proportion to the number of atoms of cobalt and nickel excluding phosphorus.

TABLE 1
Plating bath (1)

| | |
|---|---|
| nickel sulfate | 10 g/liter |
| cobalt sulfate | 10 g/liter |
| sodium hypophosphite | 15 g/liter |
| sodium citrate | 60 g/liter |
| boric acid | 30 g/liter |
| pH 8 ± 0.2 (adjusted by | NaOH and H₂SO₄) |
| liquid temperature | 80 ± 2° C. |

The surface of soft magnetic underlayer 3 was polished using colloidal silica with a mean grain diameter of 60 nm and a polishing pad of urethane form. The surface roughness Ra was 0.3 nm and the micro surface waviness Wa was 0.2 nm. Thus, substrate 10 for a perpendicular magnetic recording medium as shown in FIG. 1 was manufactured. The amount removed during polishing was about 0.5 μm. The thicknesses of soft magnetic underlayer 3 in the following descriptions are all the values after the polishing process.

When soft magnetic underlayer 3 was formed without forming adhesion layer 2 or the thickness of adhesion layer 2 was 0.05 μm, blistering occurred in soft magnetic underlayer 3. Consequently, neither the polishing nor the deposition by sputtering described later was carried out.

After cleaning disk substrate 10 for a perpendicular magnetic recording medium, the substrate was introduced into a sputtering apparatus. The substrate was heated by a lamp heater for 10 seconds to reach a surface temperature of 200° C. Nonmagnetic seed layer 20 with a thickness of 10 nm of titanium was deposited on the substrate surface using a titanium target, and subsequently magnetic recording layer 30 with a thickness of 30 nm of a CoCrPt alloy was deposited using a target of Co₇₀Cr₂₀Pt₁₀. Finally, protective layer 40 of a carbon protective film 8 nm thick was deposited using a carbon target. Then, the substrate with the deposited layers was taken out of the vacuum chamber. All of these deposition processes by sputtering were conducted by a DC magnetron sputtering method under an argon gas pressure of 5 mTorr. Next, liquid lubricant layer 2 nm thick was formed of perfluoropolyether by a dipping method, to make a perpendicular magnetic recording medium of FIG. 2.

The thus fabricated perpendicular magnetic recording medium (hard disk) was installed, along with a single pole type magnetic head for perpendicular magnetic recording, in a hard disk drive. After subjecting the hard disk drive to an impulse of 50 G for 1 ms, the flaws that occurred on the perpendicular magnetic recording medium were observed by an optical microscope. Table 2 shows the occurrence of flaws on the media with various thicknesses of the adhesion layer and the soft magnetic underlayer.

TABLE 2

| thickness of | | | |
|---|---|---|---|
| soft magnetic | thickness of Ni—P | sum of | flaws |
| underlayer (μm) | adhesion layer (μm) | thicknesses (μm) | (*) |
| 0.0 | 5.0 | 5.0 | ◯ |
| 0.2 | 1.0 | 1.2 | X |
| 0.2 | 3.0 | 3.2 | ◯ |
| 1.5 | 0.5 | 2.0 | X |
| 1.5 | 1.2 | 2.7 | Δ |
| 1.5 | 1.8 | 3.3 | ◯ |
| 1.5 | 5.0 | 6.5 | ◯ |
| 3.0 | 0.1 | 3.1 | ◯ |
| 3.0 | 1.0 | 4.0 | ◯ |
| 4.2 | 0.5 | 4.7 | ◯ |

(*) X: flaws observed Δ: micro flaws observed ◯: no flaw observed

In cases where the sum of the thicknesses of the adhesion layer and the soft magnetic underlayer was thinner than about 3 μm, the flaws occurred on the substrate surface, while in cases where the sum of the thicknesses was not smaller than about 3 μm, no flaw was detected on the medium surface.

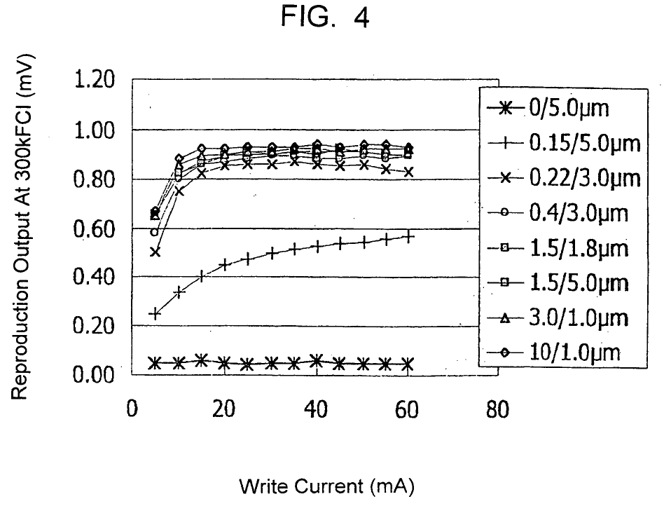

Next, the recording and reproduction performance was measured on these perpendicular magnetic recording media using a spinning stand tester equipped with a single pole type magnetic head for a perpendicular magnetic recording medium. FIG. 4 shows the dependence of the reproduced signal output at a recording density of 300 KFCl (flux change per inch) on the write current in the magnetic head. The first number is the soft magnetic underlayer thickness and the second number is the adhesion layer thickness.

In the case where the thickness of the soft magnetic underlayer was zero, that is, the case without a soft magnetic underlayer, a reproduced output was scarcely obtained. In the case where the thickness of the soft magnetic underlayer was thinner than about 0.2 μm, the reproduced output was relatively low, and further, not saturated with increase of the write current. The slow saturation of the reproduced output with increase of the write current required large current to obtain high output. Moreover, in the region of unsaturated reproduction output, the variation of the write current produced large variation of the reproduced output, which is unfavorable in practical application. In contrast, in the case where the thickness of the soft magnetic underlayer was not smaller than about 0.2 μm, a sufficient reproduction output was obtained and the reproduction output was saturated at a low write current, thus, a practically favorable medium was obtained. The media having equal thicknesses of the soft magnetic underlayer, but having different thicknesses of the adhesion layer, exhibited nearly the same dependence of the reproduced output on the write current.

### EXAMPLE 2

Substrates 10 for a perpendicular magnetic recording medium of FIG. 1 were manufactured in the same manner as in Example 1 except that the thickness of adhesion layer 2 was 5.0 μm, the thickness of the soft magnetic underlayer 3 was 1.5 μm, and the average phosphorus concentration in soft magnetic underlayer 3 was varied in the range of 3 at % to 25 at % by varying the conditions of the plating bath in the range shown in the plating bath (2) of Table 3. The average cobalt concentration in soft magnetic underlayer 3 was in the range of 67 at % to 72 at % in proportion to the number of atoms of cobalt and nickel excluding phosphorus. When the phosphorus concentration was less than 3 at %, the plating bath was found to be very unstable and unacceptable for mass production.

TABLE 3
Plating bath (2)

| | |
|---|---|
| nickel sulfate | 7-12 g/liter |
| cobalt sulfate | 7-12 g/liter |
| sodium hypophosphite | 10-30 g/liter |
| sodium citrate | 20-80 g/liter |
| sodium tartrate | 0-150 g/liter |
| sodium acetate | 0-80 g/liter |
| pH 8 ± 0.2 (adjusted by | NaCO and H₂SO₄) |
| liquid temperature | 80 ± 2° C. |

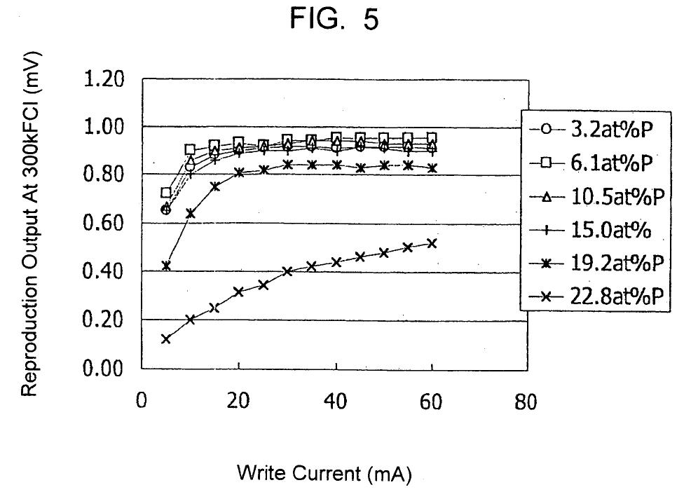

Then, perpendicular magnetic recording media of FIG. 2 were manufactured as in Example 1. The recording and reproduction performance was measured on these media as in Example 1. FIG. 5 shows the dependence of the reproduced signal output at a recording density of 300 kFCl on the write current in the magnetic head.

When the average phosphorus concentration in the soft magnetic underlayer was lower than about 20 at %, the obtained reproduction output was sufficient, while in the case where it was higher than about 22 at %, the reproduced output decreased and the saturation was slower and thus the performance was insufficient for a soft magnetic backing layer.

### EXAMPLE 3

Substrates 10 for a perpendicular magnetic recording medium of FIG. 1 were manufactured in the same manner as in Example 1 except that the thickness of the adhesion layer 2 was 5.0 μm, the thickness of the soft magnetic underlayer was 1.5 μm, and the average cobalt concentration in the soft magnetic underlayer was varied in the range of 18.8 at % to 90.9 at % in proportion to the number of atoms of cobalt and nickel excluding phosphorus varying the conditions of the plating bath in the range shown in the plating bath (3) of Table 4. The average phosphorus concentration in soft magnetic underlayer 3 was in the range of 10 at % to 20 at %.

TABLE 4
Plating bath (3)

| | |
|---|---|
| nickel sulfate | 6-18 g/liter |
| cobalt sulfate | 2-14 g/liter |
| sodium hypophosphite | 10-20 g/liter |
| sodium citrate | 60 g/liter |
| pH 6.5 ± 0.2 to 8 ± 0.2 | (adjusted by NaOH and H₂SO₄) |
| liquid temperature | 80 ± 2° C. |

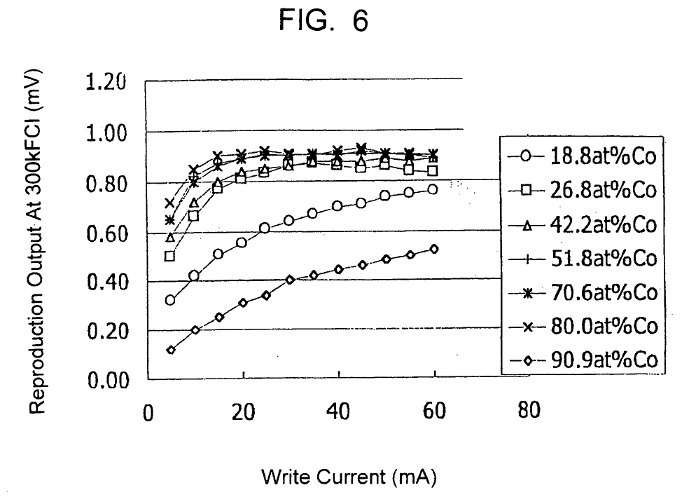

Then, perpendicular magnetic recording media of FIG. 2 were manufactured as in Example 1. The recording and reproduction performance was measured on these media as in Example 1. FIG. 6 shows the dependence of the reproduced signal output at a recording density of 300 kFCl on the write current in the magnetic head.

When the average cobalt concentration in the soft magnetic underlayer was 18.8 at % in proportion to the number of atoms of cobalt and nickel excluding phosphorus, the reproduced output was found to be weak and was not saturated with increase of the write current. In the cases where the average cobalt concentrations were 26.8 at % and 42.2 at % in proportion to the number of atoms of cobalt and nickel excluding phosphorus, the reproduced output was relatively high and the saturation was fast. The reproduced output was highest and the saturation was fastest in the cases where the average cobalt concentration was in the range of 51.8 at % to 80.0 at % in proportion to the number of atoms of cobalt and nickel excluding phosphorus. In contrast, in the case where the average cobalt concentration was 90.9 at % in proportion to the number of atoms of cobalt and nickel excluding phosphorus, the reproduced output decreased and the saturation was slow, showing insufficient performance for a soft magnetic backing layer.

### EXAMPLE 4

Substrates 10 for a perpendicular magnetic recording medium of FIG. 1 were manufactured in the same manner as in Example 1 except that the thickness of the adhesion layer 2 was 5.0 μm, the thickness of soft magnetic underlayer 3 was 1.5 μm, and the deposition rate of the plating layer of the soft magnetic underlayer 3 was varied by varying the rotating speed of the substrate in the plating bath in the range of zero to 20 rpm and by varying the plating bath temperature. The average phosphorus concentration in the soft magnetic underlayer was in the range of 10 at % to 20 at %, and the average cobalt concentration was in the range of 67 at % to 72 at % in proportion to the number of atoms of cobalt and nickel excluding phosphorus.

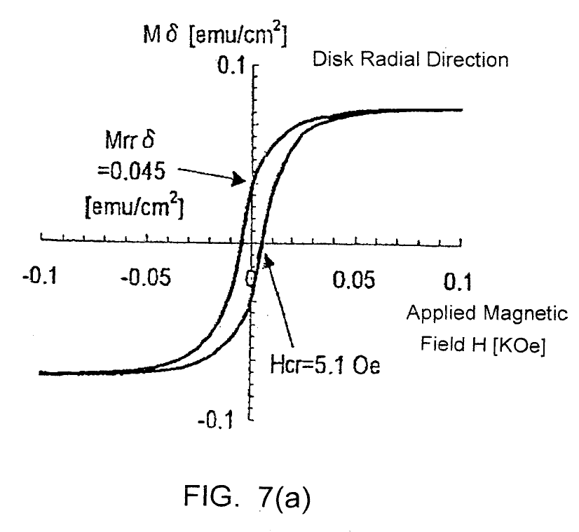

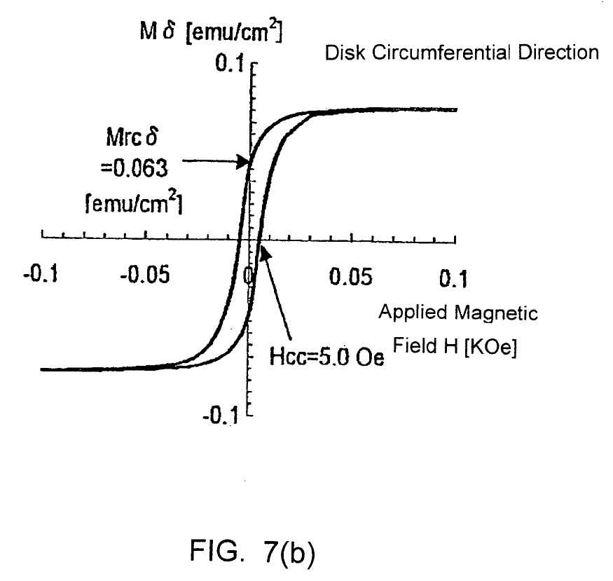

After cutting the substrate into 8 mm square and removing the plating film on one side of the substrate by polishing, the magnetization curves were measured in the disk radial direction and the disk circumferential direction using a vibrating sample magnetometer (VSM) to obtain the residual magnetizations Mrr and Mrc, and the coercivity Hcr and Hcc. FIG. 7 shows a typical magnetization curve and the definitions of the residual magnetization and coercivity. The values of Mrrδ/Mrcδ of the produced soft magnetic underlayer were in the range of 0.05 to 12.

Using the uncut disk substrates, perpendicular magnetic recording media as shown in FIG. 2 were manufactured in the same manner as in Example 1. On these perpendicular magnetic recording media, spike noise was measured using a spinning stand tester equipped with a single magnetic pole type magnetic head for a perpendicular magnetic recording medium. In the first of the measurements, direct current demagnetization of the perpendicular magnetic recording medium was carried out by supplying the writing element of the magnetic head with the dc current of 50 mA. Then, the current in the writing element was decreased to zero and the signal generated in the perpendicular magnetic recording medium was read out without writing-in.

Table 5 shows occurrence of spike noise in each perpendicular magnetic recording medium, and the value of Mrrδ/Mrcδ and mean value Hc of Hcr and Hcc obtained from the magnetization curve for the corresponding substrate.

TABLE 5

| Mrrδ/Mrcδ | Hc (Oe) | spike noises |
|---|---|---|
| 0.01 | 3 | X |
| 0.19 | 3 | X |
| 0.28 | 5 | X |
| 0.31 | 8 | □ |
| 0.35 | 11 | ◯ |
| 0.5 | 15 | ◯ |
| 1.1 | 10 | ◯ |
| 2.3 | 10 | ◯ |
| 2.9 | 7 | ◯ |
| 3.1 | 6 | X |
| 5 | 4 | X |
| 100 | 2 | X |

Symbols X, ◯, and □ respectively indicate that spike noises were generated, no spike noise was generated, and very little spike noises were generated.

The perpendicular magnetic recording medium exhibiting the value Mrrδ/Mrcδ of in the range of 0.33 to 3.0 generated no spike noise. The Hc value of the media that did not generate spike noise was not more than 20 Oe.

### EXAMPLE 5

Substrates 10 for a perpendicular magnetic recording medium of FIG. 1 were manufactured in the same manner as in Example 1 except that the thickness of adhesion layer 2 was 5.0 μm and the thickness of soft magnetic underlayer 3 was 1.5 μm. The value of Mrrδ/Mrcδ of this substrate was 1.5, which was measured using a VSM by the method described in Example 4.

After cleaning, each of these substrates 10 for perpendicular magnetic recording medium was introduced into a sputtering apparatus. Soft magnetic auxiliary layer 100 of a NiFe alloy of 0 to 100 nm was formed using a target of Ni₈OFe₂₀. Subsequent processes from substrate heating were conducted in the same manner as in Example 1, to produce a perpendicular magnetic recording medium shown in FIG. 3.

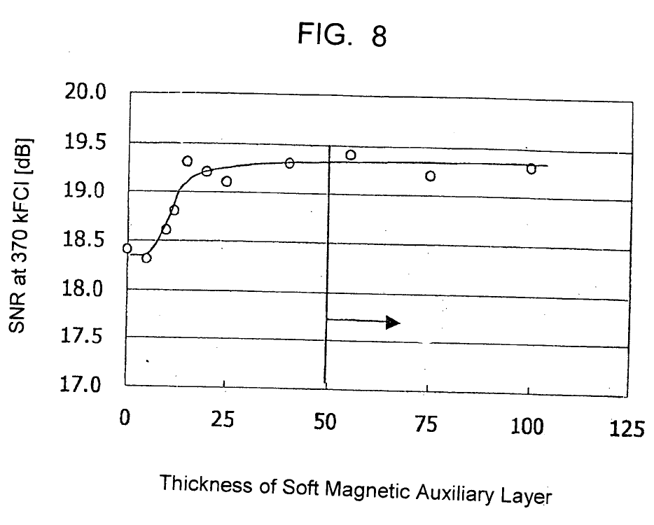

The saturation magnetic flux density of the thus formed soft magnetic auxiliary layer 100 was 10,000 G. On these perpendicular magnetic recording media, the recording and reproduction characteristics were measured using a spinning stand tester equipped with a single magnetic pole type magnetic head for a perpendicular magnetic recording medium. FIG. 8 shows the signal-to-noise ratio SNR at a recording density of 370 kFCl in the dependence on the thickness of the soft magnetic auxiliary layer. Spike noise is generated to the right of the vertical line in the graph.

The effect of SNR improvement was unsatisfactory when the thickness of the soft magnetic auxiliary layer was thinner than 15 nm, which is equivalent to the product of the thickness and the saturation magnetic flux density less than 150 G μm. Forming the soft magnetic auxiliary layer of at least 15 nm thickness achieved an improvement in SNR by 0.5 dB to 1 dB in comparison with the case without the soft magnetic auxiliary layer.

While the SNR was practically constant in the range of the thickness of 15 nm or more, the media provided with a soft magnetic auxiliary layer of 50 nm or more caused the detection of spike noise that could be attributed to the soft magnetic auxiliary layer, and found inappropriate for a perpendicular magnetic recording medium.

Thus, a substrate for a perpendicular magnetic recording medium and a perpendicular magnetic recording medium using the substrate has been described according to the present invention. Many modifications and variations may be made to the techniques and structures described and illustrated herein without departing from the spirit and scope of the invention. Accordingly, it should be understood that the substrates and media described herein are illustrative only and are not limiting upon the scope of the invention.

1. A substrate for a perpendicular magnetic recording medium, comprising:
a nonmagnetic base plate comprising an aluminum alloy,
an adhesion layer formed on the nonmagnetic base plate and comprising a material that contains at least nickel, and
a soft magnetic underlayer formed on the adhesion layer by means of an electroless plating method, said underlayer containing phosphorus in a range of 3 at % to 20 at %, and at least 25 at % of cobalt in proportion to the number of atoms of cobalt and nickel excluding the phosphorus (Co/(Co+Ni));
wherein thickness of the adhesion layer is at least 0.1 μm, thickness of the soft magnetic underlayer is at least 0.2 μm, and a sum of the thickness of the adhesion layer and the thickness of the soft magnetic underlayer is at least 3 μm.

2. The substrate for a perpendicular magnetic recording medium according to claim 1, wherein the adhesion layer comprises a nonmagnetic Ni—P alloy formed by an electroless plating method.

3. The substrate for a perpendicular magnetic recording medium according to claim 1, wherein the substrate is a disk substrate for a hard disk.

4. The substrate for a perpendicular magnetic recording medium according to claim 2, wherein the substrate is a disk substrate for a hard disk.

5. The substrate for a perpendicular magnetic recording medium according to claim 3, wherein the soft magnetic underlayer has a surface roughness Ra of at most 0.5 nm and a micro surface waviness Wa of at most 0.5 nm.

6. The substrate for a perpendicular magnetic recording medium according to claim 4, wherein the soft magnetic underlayer has a surface roughness Ra of at most 0.5 nm and a micro surface waviness Wa of at most 0.5 nm.

7. The substrate for a perpendicular magnetic recording medium according to claim 3, wherein the soft magnetic underlayer exhibits a ratio Mrr δ/Mrc δ in a range of 0.33 to 3.00, in which Mrc δ is a product of the thickness and residual magnetization obtained from a magnetization curve measured by applying a magnetic field along a circumferential direction of the disk substrate, and Mrr δ is a product of the thickness and residual magnetization obtained from a magnetization curve measured by applying a magnetic field along a radial direction of the disk substrate.

8. The substrate for a perpendicular magnetic recording medium according to claim 4, wherein the soft magnetic underlayer exhibits a ratio Mrr δ/Mrc δ in a range of 0.33 to 3.00, in which Mrc δ is a product of the thickness and residual magnetization obtained from a magnetization curve measured by applying a magnetic field along a circumferential direction of the disk substrate, and Mrr δ is a product of the thickness and residual magnetization obtained from a magnetization curve measured by applying a magnetic field along a radial direction of the disk substrate.

9. The substrate for a perpendicular magnetic recording medium according to claim 5, wherein the soft magnetic underlayer exhibits a ratio Mrr δ/Mrc δ in a range of 0.33 to 3.00, in which Mrc δ is a product of the thickness and residual magnetization obtained from a magnetization curve measured by applying a magnetic field along a circumferential direction of the disk substrate, and Mrr δ is a product of the thickness and residual magnetization obtained from a magnetization curve measured by applying a magnetic field along a radial direction of the disk substrate.

10. The substrate for a perpendicular magnetic recording medium according to claim 6, wherein the soft magnetic underlayer exhibits a ratio Mrr δ/Mrc δ in a range of 0.33 to 3.00, in which Mrc δ is a product of the thickness and residual magnetization obtained from a magnetization curve measured by applying a magnetic field along a circumferential direction of the disk substrate, and Mrr δ is a product of the thickness and residual magnetization obtained from a magnetization curve measured by applying a magnetic field along a radial direction of the disk substrate.

11. A perpendicular magnetic recording medium, comprising:
a substrate as claimed in claim 1, and
at least a nonmagnetic seed layer, a magnetic recording layer, and a protective layer sequentially formed on the substrate;
wherein the soft magnetic underlayer of the substrate is utilized as at least a part of a soft magnetic backing layer for the magnetic recording layer.

12. A perpendicular magnetic recording medium, comprising:
a substrate as claimed in claim 2, and
at least a nonmagnetic seed layer, a magnetic recording layer, and a protective layer sequentially formed on the substrate;
wherein the soft magnetic underlayer of the substrate is utilized as at least a part of a soft magnetic backing layer for the magnetic recording layer.

13. A perpendicular magnetic recording medium, comprising:
a substrate as claimed in claim 3, and
at least a nonmagnetic seed layer, a magnetic recording layer, and a protective layer sequentially formed on the substrate;
wherein the soft magnetic underlayer of the substrate is utilized as at least a part of a soft magnetic backing layer for the magnetic recording layer.

14. A perpendicular magnetic recording medium, comprising:
a substrate as claimed in claim 5, and
at least a nonmagnetic seed layer, a magnetic recording layer, and a protective layer sequentially formed on the substrate;
wherein the soft magnetic underlayer of the substrate is utilized as at least a part of a soft magnetic backing layer for the magnetic recording layer.

15. A perpendicular magnetic recording medium, comprising:
a substrate as claimed in claim 7, and
at least a nonmagnetic seed layer, a magnetic recording layer, and a protective layer sequentially formed on the substrate;
wherein the soft magnetic underlayer of the substrate is utilized as at least a part of a soft magnetic backing layer for the magnetic recording layer.

16. The perpendicular magnetic recording medium according to claim 12, further comprising at least a soft magnetic auxiliary layer having a thickness of at most 50 nm and exhibiting a product of the thickness and a saturation magnetic flux density of at least 150 G μm, disposed between the soft magnetic underlayer of the substrate and the nonmagnetic seed layer.

17. The perpendicular magnetic recording medium according to claim 13, further comprising at least a soft magnetic auxiliary layer having a thickness of at most 50 nm and exhibiting a product of the thickness and a saturation magnetic flux density of at least 150 G μm, disposed between the soft magnetic underlayer of the substrate and the nonmagnetic seed layer.

18. The perpendicular magnetic recording medium according to claim 14, further comprising at least a soft magnetic auxiliary layer having a thickness of at most 50 nm and exhibiting a product of the thickness and a saturation magnetic flux density of at least 150 G μm, disposed between the soft magnetic underlayer of the substrate and the nonmagnetic seed layer.

19. The perpendicular magnetic recording medium according to claim 15, further comprising at least a soft magnetic auxiliary layer having a thickness of at most 50 nm and exhibiting a product of the thickness and a saturation magnetic flux density of at least 150 G μm, disposed between the soft magnetic underlayer of the substrate and the nonmagnetic seed layer.
